(19) United States
(12) Patent Application Publication
(10) Pub. No.: US 2020/0110447 A1
(43) Pub. Date: Apr. 9, 2020

(54) SUBSTRATE(S) ENCLOSED BY ENERGY ABSORBING MATERIAL(S)

(71) Applicant: Hewlett-Packard Development Company, L.P., Spring, TX (US)

(72) Inventors: Kuan-Ting Wu, Taipei (TW); Ya-Ting Yeh, Taipei (TW); Shih-Hsun Huang, Taipei (TW)

(73) Assignee: Hewlett-Packard Development Company, L.P., Spring, TX (US)

(21) Appl. No.: 16/499,615

(22) PCT Filed: Apr. 14, 2017
(86) PCT No.: PCT/US2017/027647

§ 371 Date: Sep. 30, 2019

(51) Int. Cl. G06F 1/18

(52) U.S. Cl. CPC G06F 1/182; H04B 1/38; G06F 2200/1633

(57) ABSTRACT

Electronic devices comprising a substrate at least partially enclosed by an energy absorbing material are disclosed herein. The energy absorbing material can integrally or removably attach to the substrate. The substrate can be carbon fiber, glass, ceramic, metal, composite, or mixtures thereof. The energy absorbing material can comprise at least one thermoplastic polymer.

### BACKGROUND

Electronic devices such as desktop computers, laptop computers, mobile phones, handheld devices, printing devices, and other electronic devices can experience mechanical stresses during use by a customer, during shipping, or during storage. These mechanical stresses can include but are not limited to accidental dropping and objects falling on the electronic devices.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a perspective view of an electronic device substrate enclosed by an energy absorbing material according to an example;

FIG. 1A is a cross-sectional view of the electronic device substrate enclosed by the energy absorbing material shown in FIG. 1;

FIG. 2 is a perspective view of an electronic device substrate enclosed by an energy absorbing material according to an example;

FIG. 2A is a cross-sectional view of the electronic device substrate enclosed by the energy absorbing material shown in FIG. 2;

FIG. 3 is a perspective view of an electronic device substrate enclosed by an energy absorbing material according to an example;

FIG. 3A is a cross-sectional view of the electronic device substrate enclosed by the energy absorbing material shown in FIG. 3;

FIG. 4 is a perspective view of an electronic device substrate enclosed by an energy absorbing material according to an example;

FIG. 4A is a cross-sectional view of the electronic device substrate enclosed by the energy absorbing material shown in FIG. 4;

FIG. 5 is a perspective view of an electronic device substrate enclosed by an energy absorbing material according to an example;

FIG. 5A is a cross-sectional view of the electronic device substrate enclosed by the energy absorbing material shown in FIG. 5;

FIG. 6 is a perspective view of an electronic device substrate enclosed by an energy absorbing material according to an example;

FIG. 6A is a cross-sectional view of the electronic device substrate enclosed by the energy absorbing material shown in FIG. 6;

FIG. 7 is a perspective view of an electronic device substrate enclosed by an energy absorbing material according to an example;

FIG. 7A is a cross-sectional view of the electronic device substrate enclosed by the energy absorbing material shown in FIG. 7;

FIG. 8 is a perspective view of an electronic device substrate enclosed by an energy absorbing material according to an example; and

FIG. 8A is a cross-sectional view of the electronic device substrate enclosed by the energy absorbing material shown in FIG. 8.

### DETAILED DESCRIPTION

To protect electronic devices from breaking or malfunctions due to mechanical stresses, it would be helpful to increase the mechanical strength of these electronic devices without significant increases in cost or weight of the devices.

Several electronic devices such as desktop computers, laptop computers, hand-held mobile terminals, communication units (e.g., phones), and the like can be generally susceptible to physical damage (e.g., device failure or malfunctions) during customer use, during shipping, or during storage. The failure or malfunctions can occur from damage to internal components.

Electronic devices are generally assembled by enclosing internal electrical components, such as a central processing unit (CPU) board, display, keyboard, and/or internal wiring, within a housing made of plastic or another structural material. This enclosure normally serves as a protective housing but does not have the capacity to handle any significant mechanical stresses because the protective housing can have a hardness of less than about 30 Shore A.

There is, therefore, a need for electronic devices to have substrate enclosing materials that can handle mechanical stresses including but not limited to dropping of the electronic device or an object falling on the electronic device.

In some examples, described is an electronic device comprising: a substrate at least partially enclosed by an energy absorbing material, wherein the energy absorbing material integrally or removably attaches to the substrate, wherein the substrate is carbon fiber, glass, ceramic, metal, composite, or mixtures thereof, and wherein the energy absorbing material comprises at least one thermoplastic polymer.

The electronic device is not limited to and can include desktop computers, laptop computers, mobile phones, handheld devices, and printing devices.

In some examples, the energy absorbing material integrally attaches to the substrate.

The substrate can include any internal component or flat surface of an electronic device—e.g., CPU board, display, and keyboard.

In some examples, the at least one thermoplastic polymer further comprises a toughening agent.

In some examples, the toughening agent is a fluorinated hydrocarbon, a natural rubber, polyisoprene, polychloroprene, a styrene butadiene rubber, a nitrile butadiene rubber, an ethylene propylene diene monomer rubber, a polybutadiene/butyl rubber, epichlorohydrin, a silicone rubber, or combinations thereof.

In some examples, the toughening agent is present in the energy absorbing material in an amount of from about 20-60 wt % based on the total weight of the energy absorbing material, or the toughening agent is present in the energy absorbing material in an amount of from about 25-55 wt % based on the total weight of the energy absorbing material, or the toughening agent is present in the energy absorbing material in an amount of from about 30-50 wt % based on the total weight of the energy absorbing material, or the toughening agent is present in the energy absorbing material in an amount of from about 35-45 wt % based on the total weight of the energy absorbing material, or the toughening agent is present in the energy absorbing material in an amount of from about 10-20 wt % based on the total weight of the energy absorbing material, or the toughening agent is present in the energy absorbing material in an amount of from about 5-10 wt % based on the total weight of the energy absorbing material, or the toughening agent is present in the energy absorbing material in an amount of from about 60-70 wt % based on the total weight of the energy absorbing material.

In some examples, the at least one thermoplastic polymer is a styrene block copolymer, a polyolefin blend, an elastomeric alloy, a thermoplastic polyurethane, a thermoplastic copolyester, a thermoplastic polyamide, or combinations thereof.

In some examples, the thermoplastic polymer is present in the energy absorbing material in an amount of from about 15-55 wt % based on the total weight of the energy absorbing material, or the thermoplastic polymer is present in the energy absorbing material in an amount of from about 20-50 wt % based on the total weight of the energy absorbing material, or the thermoplastic polymer is present in the energy absorbing material in an amount of from about 25-45 wt % based on the total weight of the energy absorbing material, or the thermoplastic polymer is present in the energy absorbing material in an amount of from about 30-40 wt % based on the total weight of the energy absorbing material, or the thermoplastic polymer is present in the energy absorbing material in an amount of from about 5-15 wt % based on the total weight of the energy absorbing material, or the thermoplastic polymer is present in the energy absorbing material in an amount of from about 55-70 wt % based on the total weight of the energy absorbing material.

In some examples, the at least one thermoplastic polymer further comprises a toughening agent, wherein the toughening agent is present in the energy absorbing material in an amount of from about 20-60 wt % based on the total weight of the energy absorbing material, and wherein the thermoplastic polymer is present in the energy absorbing material in an amount of from about 15-55 wt % based on the total weight of the energy absorbing material.

In some examples, the at least one thermoplastic polymer further comprises a toughening agent, wherein the toughening agent is present in the energy absorbing material in an amount of from about 20-60 wt % based on the total weight of the energy absorbing material, wherein the thermoplastic polymer is present in the energy absorbing material in an amount of from about 15-55 wt % based on the total weight of the energy absorbing material, and wherein the energy absorbing material further comprises a thermoset resin.

In some examples, the thermoset resin is present in the energy absorbing material in an amount of from about 15-55 wt % based on the total weight of the energy absorbing material, or the thermoset resin is present in the energy absorbing material in an amount of from about 20-50 wt % based on the total weight of the energy absorbing material, or the thermoset resin is present in the energy absorbing material in an amount of from about 25-45 wt % based on the total weight of the energy absorbing material, or the thermoset resin is present in the energy absorbing material in an amount of from about 30-40 wt % based on the total weight of the energy absorbing material, or the thermoset resin is present in the energy absorbing material in an amount of from about 5-15 wt % based on the total weight of the energy absorbing material, or the thermoset resin is present in the energy absorbing material in an amount of from about 55-70 wt % based on the total weight of the energy absorbing material.

In some examples, the at least one thermoplastic polymer further comprises a toughening agent, wherein the toughening agent is present in the energy absorbing material in an amount of from about 20-60 wt % based on the total weight of the energy absorbing material, wherein the thermoplastic polymer is present in the energy absorbing material in an amount of from about 25-65 wt % based on the total weight of the energy absorbing material, wherein the energy absorbing material further comprises a thermoset resin, and wherein the thermoset resin is present in the energy absorbing material in an amount of from about 15-55 wt % based on the total weight of the energy absorbing material.

In some examples, the energy absorbing material can have a hardness of from about 30 Shore A to about 100 Shore A, or the energy absorbing material can have a hardness of from about 35 Shore A to about 97 Shore A, or the energy absorbing material can have a hardness of from about 40 Shore A to about 95 Shore A, or the energy absorbing material can have a hardness of from about 45 Shore A to about 92 Shore A, or the energy absorbing material can have a hardness of from about 50 Shore A to about 90 Shore A, or the energy absorbing material can have a hardness of from about 55 Shore A to about 88 Shore A, or the energy absorbing material can have a hardness of from about 60 Shore A to about 85 Shore A, or the energy absorbing material can have a hardness of from about 65 Shore A to about 82 Shore A, or the energy absorbing material can have a hardness of from about 70 Shore A to about 80 Shore A.

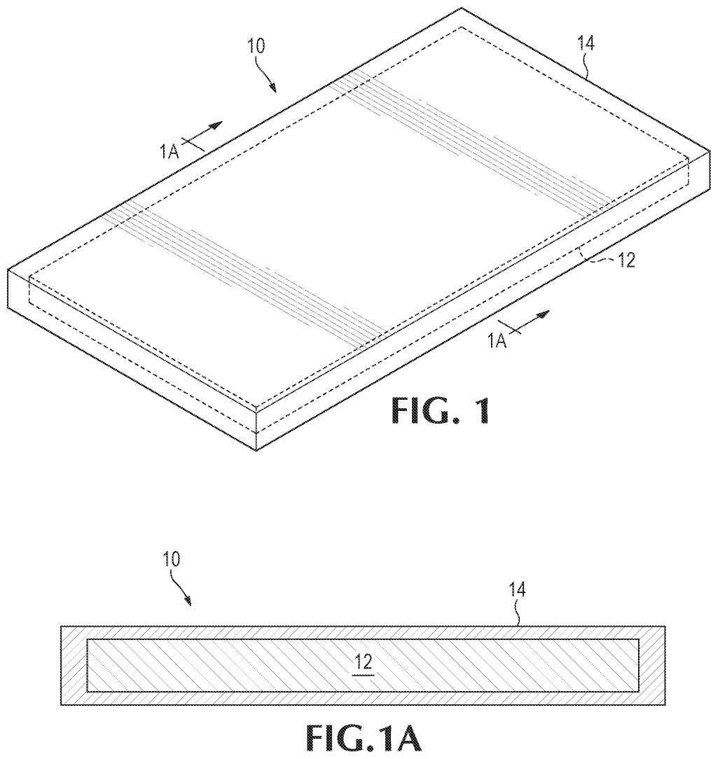

FIG. 1 is a perspective view of an electronic device substrate enclosed by an energy absorbing material according to an example. In FIG. 1, an enclosed electronic device substrate 10 includes a substrate 12, which is fully enclosed by an energy absorbing material 14. In this example, the substrate 12 is enclosed by the energy absorbing material 14 on a top surface of the substrate 12, a bottom surface of the substrate 12, and all edges of the substrate 12.

FIG. 1A is a cross-sectional view taken along line 1A of the enclosed electronic device substrate 10 shown in FIG. 1. In FIG. 1A, the substrate 12 is shown as fully enclosed by the energy absorbing material 14 on the top surface of the substrate 12, the bottom surface of the substrate 12, and all the edges of the substrate 12.

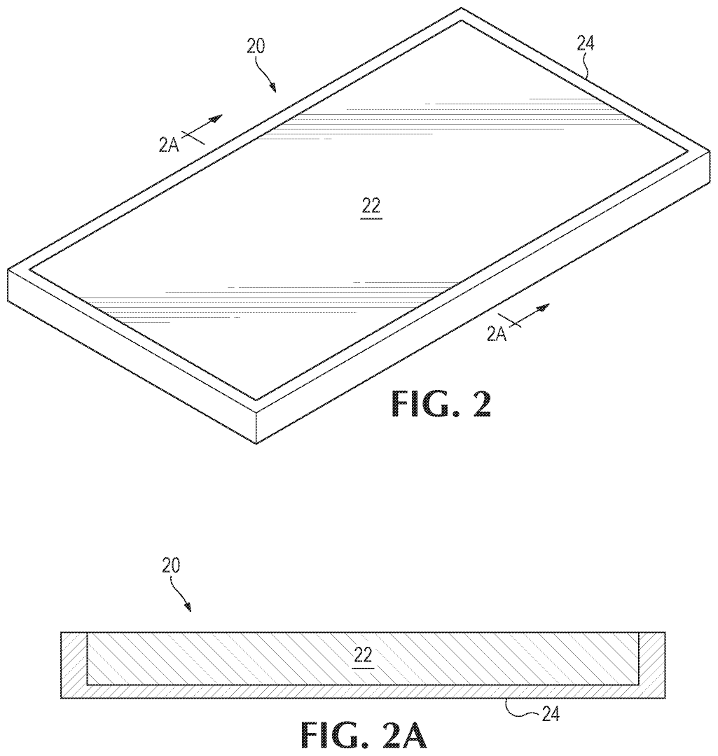

FIG. 2 is a perspective view of an electronic device substrate enclosed by an energy absorbing material according to an example. In FIG. 2, an enclosed electronic device substrate 20 includes a substrate 22, which is partially enclosed by an energy absorbing material 24. In this example, the substrate 22 is enclosed by the energy absorbing material 24 on a bottom surface of the substrate 22 and all edges of the substrate 22.

FIG. 2A is a cross-sectional view taken along line 2A of the enclosed electronic device substrate 20 shown in FIG. 2. In FIG. 2A, the substrate 22 is shown as partially enclosed by the energy absorbing material 24 on the bottom surface of the substrate 22 and all the edges of the substrate 22.

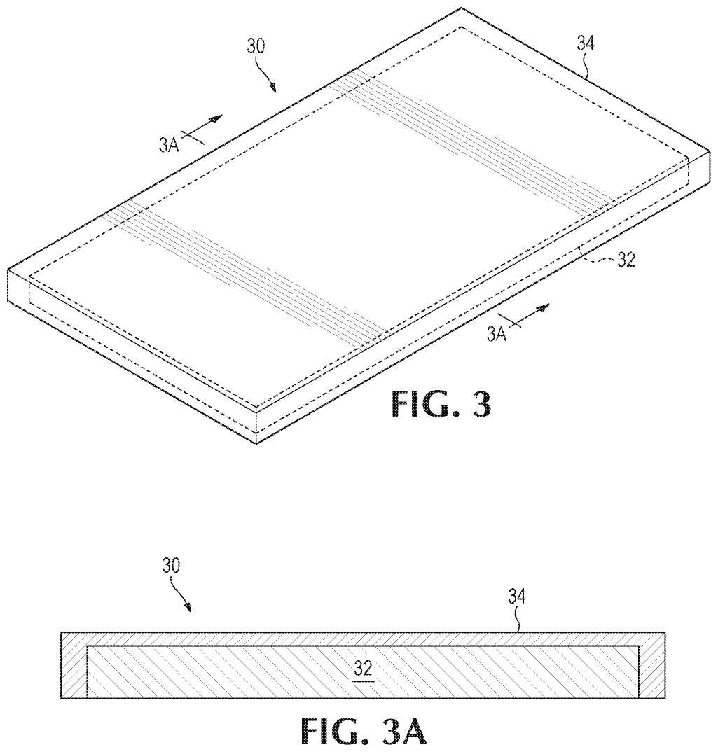

FIG. 3 is a perspective view of an electronic device substrate enclosed by an energy absorbing material according to an example. In FIG. 3, an enclosed electronic device substrate 30 includes a substrate 32, which is partially enclosed by an energy absorbing material 34. In this example, the substrate 32 is enclosed by the energy absorbing material 44 on a top surface of the substrate 32 and all edges of the substrate 32.

FIG. 3A is a cross-sectional view taken along line 3A of the enclosed electronic device substrate 30 shown in FIG. 3. In FIG. 3A, the substrate 32 is shown as partially enclosed by the energy absorbing material 34 on the top surface of the substrate 32 and all the edges of the substrate 32.

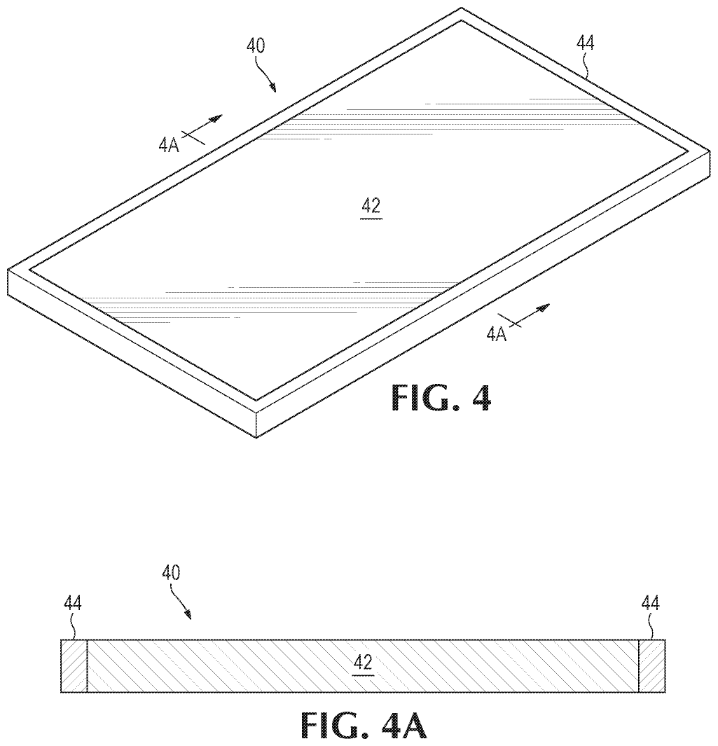

FIG. 4 is a perspective view of an electronic device substrate enclosed by an energy absorbing material according to an example. In FIG. 4, an enclosed electronic device substrate 40 includes a substrate 42, which is partially enclosed by an energy absorbing material 44. In this example, the substrate 42 is enclosed by the energy absorbing material 44 on all edges of the substrate 42.

FIG. 4A is a cross-sectional view taken along line 4A of the enclosed electronic device substrate 40 shown in FIG. 4. In FIG. 4A, the substrate 42 is shown as partially enclosed by the energy absorbing material 44 on all the edges of the substrate 42.

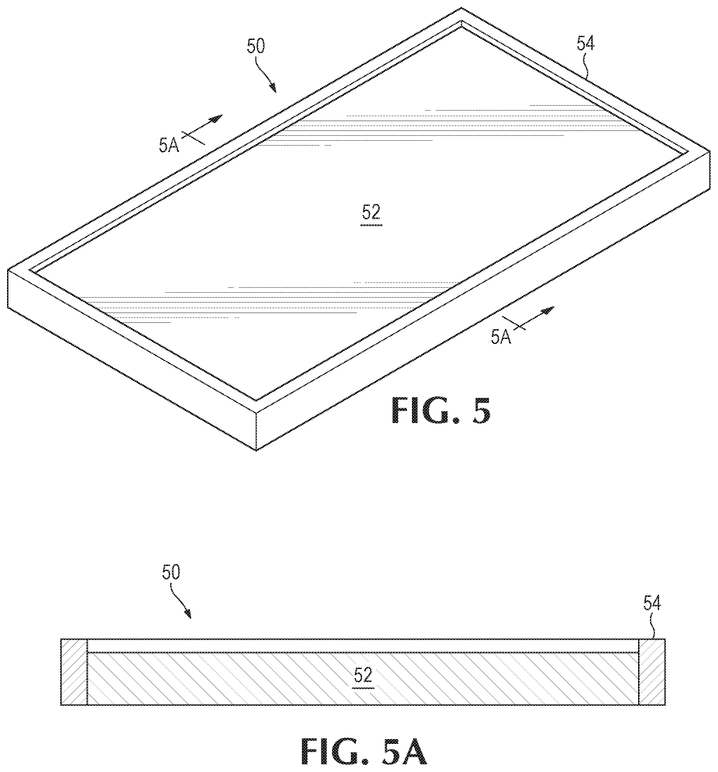

FIG. 5 is a perspective view of an electronic device substrate enclosed by an energy absorbing material according to an example. In FIG. 5, an enclosed electronic device substrate 50 includes a substrate 52, which is partially enclosed by an energy absorbing material 54. In this example, the substrate 52 is enclosed by the energy absorbing material 54 on all edges of the substrate 52 while extending above a top surface of the substrate 52.

FIG. 5A is a cross-sectional view taken along line 5A of the enclosed electronic device substrate 50 shown in FIG. 5. In FIG. 5A, the substrate 52 is shown as partially enclosed by the energy absorbing material 54 on all the edges of the substrate 52 and extending above the top surface of the substrate 52.

In some examples, an extension of an energy absorbing material above a top surface of a substrate can be from about 0.05 mm to about 5 mm, or the extension above the top surface of the substrate can be from about 0.1 mm to about 3 mm, or the extension above the top surface of the substrate can be from about 0.3 mm to about 1 mm, or the extension above the top surface of the substrate can be less than about 0.1 mm.

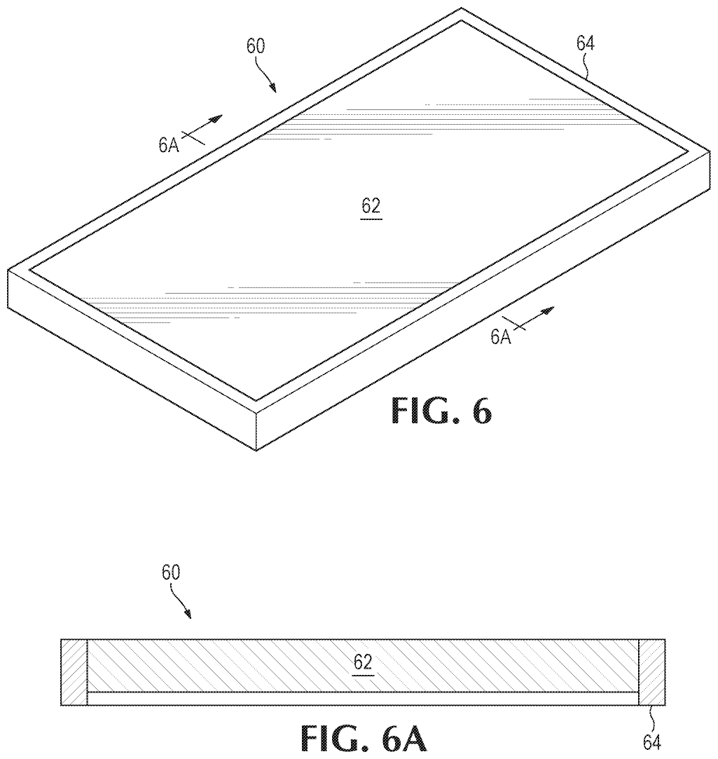

FIG. 6 is a perspective view of an electronic device substrate enclosed by an energy absorbing material according to an example. In FIG. 6, an enclosed electronic device substrate 60 includes a substrate 62, which is partially enclosed by an energy absorbing material 64. In this example, the substrate 62 is enclosed by the energy absorbing material 64 on all edges of the substrate 62 while extending below a bottom surface of the substrate 62.

FIG. 6A is a cross-sectional view taken along line 6A of the enclosed electronic device substrate 60 shown in FIG. 6. In FIG. 6A, the substrate 62 is shown as partially enclosed by the energy absorbing material 64 on all the edges of the substrate 62 and extending below the bottom surface of the substrate 62.

In some examples, an extension of an energy absorbing material below a bottom surface of a substrate can be from about 0.05 mm to about 5 mm, or the extension below the bottom surface of the substrate can be from about 0.1 mm to about 3 mm, or the extension below the bottom surface of the substrate can be from about 0.3 mm to about 1 mm, or the extension below the bottom surface of the substrate can be less than about 0.1 mm.

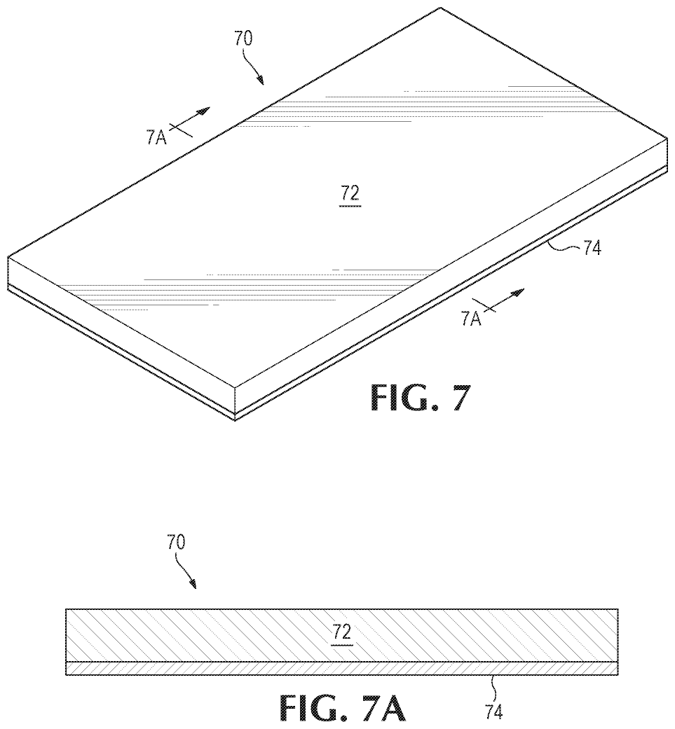

FIG. 7 is a perspective view of an electronic device substrate enclosed by an energy absorbing material according to an example. In FIG. 7, an enclosed electronic device substrate 70 includes a substrate 72, which is partially enclosed by an energy absorbing material 74. In this example, the substrate 72 is enclosed by the energy absorbing material 74 on a bottom surface of the substrate 72.

FIG. 7A is a cross-sectional view taken along line 7A of the enclosed electronic device substrate 70 shown in FIG. 7. In FIG. 7A, the substrate 72 is shown as partially enclosed by the energy absorbing material 74 on the bottom surface of the substrate 72.

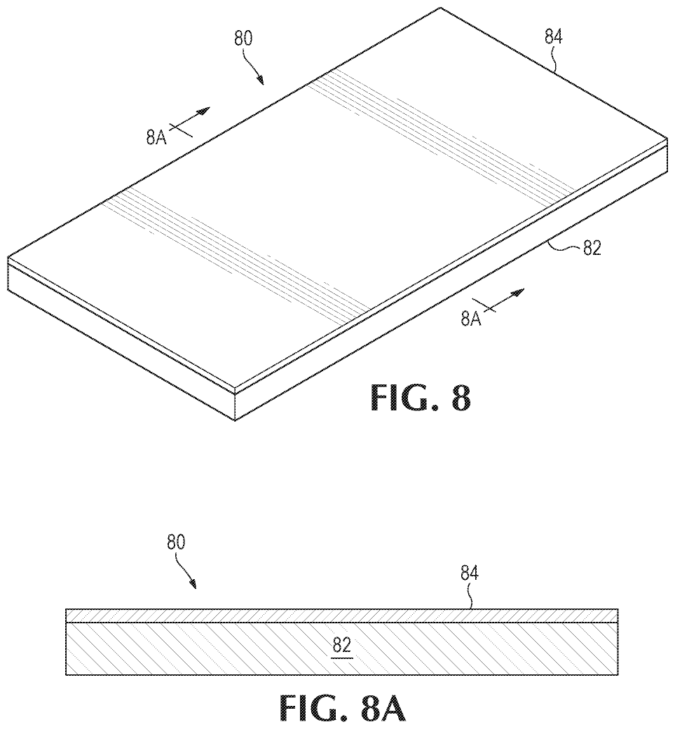

FIG. 8 is a perspective view of an electronic device substrate enclosed by an energy absorbing material according to an example. In FIG. 8, an enclosed electronic device substrate 80 includes a substrate 82, which is partially enclosed by an energy absorbing material 84. In this example, the substrate 82 is enclosed by the energy absorbing material 84 on a top surface of the substrate 82.

FIG. 8A is a cross-sectional view taken along line 8A of the enclosed electronic device substrate 80 shown in FIG. 8. In FIG. 8A, the substrate 82 is shown as partially enclosed by the energy absorbing material 84 on the top surface of the substrate 82.

In some examples, the substrate is completely enclosed by the energy absorbing material.

“Completely enclosed,” as used herein, refers to the substrate enclosed by the energy absorbing material on all surfaces of the substrate. It will be understood, however, that any port accesses or other openings can be allowed in the energy absorbing material for connectivity and/or functioning.

“Substrate(s) enclosed by energy absorbing material(s),” as used herein refers to electronic device substrates at least partially enclosed by at least one energy absorbing material. It will be understood, however, that any port accesses or other openings can be allowed in the energy absorbing material for connectivity and/or functioning.

“Partially enclosed,” as used herein, refers to the substrate enclosed by the energy absorbing material on at least one surface of the substrate but not all surfaces of the substrate. It will be understood that a substrate, as used herein, can have more than four sides. It will be understood, however, that any port accesses or other openings can be allowed in the energy absorbing material for connectivity and/or functioning.

In some examples, the substrate is enclosed by the energy absorbing material on a bottom surface of the substrate (e.g., FIG. 7 and FIG. 7A).

In some examples, the substrate is enclosed by the energy absorbing material on a top surface of the substrate (e.g., FIG. 8 and FIG. 8A).

In some examples, the substrate is enclosed by the energy absorbing material on at least one side edge of the substrate. Examples of this can include examples shown in FIG. 4, FIG. 4A, FIG. 5, FIG. 5A, FIG. 6, and FIG. 6A.

Other examples can include, at least one edge of the substrate not enclosed by the energy absorbing material (not shown in the figures).

In some examples, described is an enclosed substrate comprising: a substrate comprising carbon fiber, glass, ceramic, metal, composite, or mixtures thereof; an energy absorbing material at least partially enclosing the substrate, wherein the energy absorbing material integrally or removably attaches to the substrate, wherein the energy absorbing material comprises at least one thermoplastic polymer and a toughening agent, wherein the toughening agent is present in the energy absorbing material in an amount of from about 20-60 wt % based on the total weight of the energy absorbing material, and wherein the thermoplastic polymer is present in the energy absorbing material in an amount of from about 15-55 wt % based on the total weight of the energy absorbing material.

In some examples, the substrate is enclosed by the energy absorbing material on a bottom surface of the substrate; wherein the substrate is enclosed by the energy absorbing material on a top surface of the substrate; and/or wherein the substrate is enclosed by the energy absorbing material on at least one side edge of the substrate.

In some examples, described is a method of making an enclosed substrate, the method comprising: enclosing a substrate comprising glass, ceramic, metal, composite, or mixtures thereof with an energy absorbing material to at least partially enclose the substrate, wherein the energy absorbing material integrally or removably attaches to the substrate, wherein the energy absorbing material comprises at least one thermoplastic polymer and a toughening agent, wherein the toughening agent is present in the energy absorbing material in an amount of from about 20-60 wt % based on the total weight of the energy absorbing material, and wherein the thermoplastic polymer is present in the energy absorbing material in an amount of from about 15-55 wt % based on the total weight of the energy absorbing material.

In some examples, the energy absorbing material can be integrally or removably attached to the substrate. In some examples, integral or removable attachment can be completed by a batch process (e.g., die casting or molding) or a continuous process (e.g., molding or permanent deposition assembly process).

A batch process or continuous process can include manually or by a machine enclosing at least part of a substrate with an energy absorbing material. In some examples, an adhesive can be used to aid enclosing the substrate with the energy absorbing material. The adhesive can be a commonly used adhesive comprising an epoxy or a silane.

In some examples, a substrate enclosed by an energy absorbing material can be made from one or a combination of the following methods. One method can include a surface treatment of the substrate surface(s). In some examples, no surface treatment may be carried out.

In some examples, the substrate can be at least partially enclosed by the energy absorbing material by injection molding, a substrate may be set inside a mold, and the energy absorbing material may be injected into the mold. Reaction injection molding may be used to produce a thermoset cover.

Alternatively, another method that may be used involves pre-molding at least a part of the energy absorbing material by die casting or another molding method, enclosing the substrate in the pre-molded energy absorbing material, and compression-molding at, for example, between about 120° C. and 170° C. for a period of about one to about five minutes to attach the pre-molded energy absorbing material around the substrate.

In another method, the energy absorbing material may be cast around the substrate. The energy absorbing material can be cured in a closed mold. The casting process may be performed under nitrogen. A portion of the energy absorbing material may be formed in a mold over the substrate, then another portion of the energy absorbing material can be assembled to the first portion and cured to form a finished enclosure. The surface of the substrate may be surface-treated before the energy absorbing material is formed over it to increase the adhesion between the substrate and the enclosure.

In some examples, a thickness of the energy absorbing material on the substrate can be from about 0.01 mm to about 10 mm, or a thickness of the energy absorbing material on the substrate can be from about 0.1 mm to about 1 mm, or a thickness of the energy absorbing material on the substrate can be from about 0.5 mm to about 1 mm, or a thickness of the energy absorbing material on the substrate can be less than about 20 mm, or a thickness of the energy absorbing material on the substrate can be less than about 15 mm, ora thickness of the energy absorbing material on the substrate can be less than about 10 mm, or a thickness of the energy absorbing material on the substrate can be less than about 5 mm, or a thickness of the energy absorbing material on the substrate can be between about 10 mm and 150 mm, ora thickness of the energy absorbing material on the substrate can be between about 10 mm and 100 mm.

In some examples, at a point of contact during dropping or a falling object, the energy absorbing material enclosure can crush. The energy to crush the energy absorbing material enclosure is absorbed by the energy absorbing material enclosure instead of enclosed substrates.

In some examples, the energy absorbing materials can act as a barrier between the enclosed substrate and the point of contact (e.g., ground or an object falling on the electronic device). The energy absorbing materials can absorb impact energy without causing glass or ceramic substrate breakage and metal or composite substrate deformation.

Materials for a substrate and an energy absorbing material both of which are described hereinabove, can be purchased from manufacturers or can be prepared using known techniques/methods.

In some examples, the energy absorbing materials can have return-to-shape after application of dynamic stress. The energy absorbing materials can further offer a light-weight solution to protecting electronic devices.

Unless otherwise stated, any feature described hereinabove can be combined with any example or any other feature described herein.

In describing and claiming the examples disclosed herein, the singular forms “a,” “an,” and “the” include plural referents unless the context clearly dictates otherwise.

It is to be understood that concentrations, amounts, and other numerical data may be expressed or presented herein in range formats. It is to be understood that such range formats are used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same applies to ranges reciting a single numerical value.

Reference throughout the specification to “one example,” “some examples,” “another example,” “an example,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

Unless otherwise stated, references herein to “wt %” of a component are to the weight of that component as a percentage of the whole composition comprising that component. For example, references herein to “wt %” of, for example, a solid material such as polyurethane(s) or colorant(s) dispersed in a liquid composition are to the weight percentage of those solids in the composition, and not to the amount of that solid as a percentage of the total non-volatile solids of the composition.

If a standard test is mentioned herein, unless otherwise stated, the version of the test to be referred to is the most recent at the time of filing this patent application.

All amounts disclosed herein and in the examples below are in wt % unless indicated otherwise.

While several examples have been described in detail, it is to be understood that the disclosed examples may be modified. Therefore, the foregoing description is to be considered non-limiting.

What is claimed is:

1. An electronic device comprising:
a substrate at least partially enclosed by an energy absorbing material,
wherein the energy absorbing material integrally or removably attaches to the substrate,
wherein the substrate is carbon fiber, glass, ceramic, metal, composite, or mixtures thereof, and
wherein the energy absorbing material comprises at least one thermoplastic polymer.

2. The electronic device of claim 1, wherein the energy absorbing material integrally attaches to the substrate.

3. The electronic device of claim 1, wherein the at least one thermoplastic polymer further comprises a toughening agent.

4. The electronic device of claim 3, wherein the toughening agent is a fluorinated hydrocarbon, a natural rubber, polyisoprene, polychloroprene, a styrene butadiene rubber, a nitrile butadiene rubber, an ethylene propylene diene monomer rubber, a polybutadiene/butyl rubber, epichlorohydrin, a silicone rubber, or combinations thereof.

5. The electronic device of claim 1, wherein the at least one thermoplastic polymer is a styrene block copolymer, a polyolefin blend, an elastomeric alloy, a thermoplastic polyurethane, a thermoplastic copolyester, a thermoplastic polyamide, or combinations thereof.

6. The electronic device of claim 1,
wherein the at least one thermoplastic polymer further comprises a toughening agent,
wherein the toughening agent is present in the energy absorbing material in an amount of from about 20-60 wt % based on the total weight of the energy absorbing material, and
wherein the thermoplastic polymer is present in the energy absorbing material in an amount of from about 15-55 wt % based on the total weight of the energy absorbing material.

7. The electronic device of claim 1,
wherein the at least one thermoplastic polymer further comprises a toughening agent,
wherein the toughening agent is present in the energy absorbing material in an amount of from about 20-60 wt % based on the total weight of the energy absorbing material,
wherein the thermoplastic polymer is present in the energy absorbing material in an amount of from about 15-55 wt % based on the total weight of the energy absorbing material, and
wherein the energy absorbing material further comprises a thermoset resin.

8. The electronic device of claim 1,
wherein the at least one thermoplastic polymer further comprises a toughening agent,
wherein the toughening agent is present in the energy absorbing material in an amount of from about 20-60 wt % based on the total weight of the energy absorbing material,
wherein the thermoplastic polymer is present in the energy absorbing material in an amount of from about 25-65 wt % based on the total weight of the energy absorbing material,
wherein the energy absorbing material further comprises a thermoset resin, and
wherein the thermoset resin is present in the energy absorbing material in an amount of from about 15-55 wt % based on the total weight of the energy absorbing material.

9. The electronic device of claim 1, wherein the substrate is completely enclosed by the energy absorbing material.

10. The electronic device of claim 1, wherein the substrate is enclosed by the energy absorbing material on a bottom surface of the substrate.

11. The electronic device of claim 1, wherein the substrate is enclosed by the energy absorbing material on a top surface of the substrate.

12. The electronic device of claim 1, wherein the substrate is enclosed by the energy absorbing material on at least one side edge of the substrate.

13. An enclosed substrate comprising:
a substrate comprising carbon fiber, glass, ceramic, metal, composite, or mixtures thereof;
an energy absorbing material at least partially enclosing the substrate,
wherein the energy absorbing material integrally or removably attaches to the substrate,
wherein the energy absorbing material comprises at least one thermoplastic polymer and a toughening agent,
wherein the toughening agent is present in the energy absorbing material in an amount of from about 20-60 wt % based on the total weight of the energy absorbing material, and
wherein the thermoplastic polymer is present in the energy absorbing material in an amount of from about 15-55 wt % based on the total weight of the energy absorbing material.

14. The enclosed substrate of claim 13,
wherein the substrate is enclosed by the energy absorbing material on a bottom surface of the substrate;
wherein the substrate is enclosed by the energy absorbing material on a top surface of the substrate; and/or
wherein the substrate is enclosed by the energy absorbing material on at least one side edge of the substrate.

15. A method of making an enclosed substrate, the method comprising:
enclosing a substrate comprising glass, ceramic, metal, composite, or mixtures thereof with an energy absorbing material to at least partially enclose the substrate,
wherein the energy absorbing material integrally or removably attaches to the substrate,
wherein the energy absorbing material comprises at least one thermoplastic polymer and a toughening agent,
wherein the toughening agent is present in the energy absorbing material in an amount of from about 20-60 wt % based on the total weight of the energy absorbing material, and
wherein the thermoplastic polymer is present in the energy absorbing material in an amount of from about 15-55 wt % based on the total weight of the energy absorbing material.
